(19) United States
(12) Patent Application Publication
(10) Pub. No.: US 2020/0049511 A1
(43) Pub. Date: Feb. 13, 2020

(54) SENSOR FUSION

(71) Applicant: Ford Global Technologies, LLC, Dearborn, MI (US)

(72) Inventors: Rajiv Sithiravel, Scarborough/Ontario (CA); David LaPorte, Livonia, MI (US); Kyle J. Carey, Ypsilanti, MI (US)

(73) Assignee: Ford Global Technologies, LLC, Dearborn, MI (US)

(21) Appl. No.: 16/057,155

(22) Filed: Aug. 7, 2018

(51) Int. Cl. G01C 21/28; G01S 17/89; G01S 17/93; G01S 13/89; G01S 13/86; G05D 1/02; B60W 10/04; B60W 10/18; B60W 10/20

(52) U.S. Cl. CPC G01C 21/28; G05D 2201/0213; G01S 17/936; G01S 13/89; G01S 13/867; G05D 1/0257; G05D 1/0246; B60W 10/04; B60W 10/18; B60W 10/20; B60W 2550/10; B60W 2550/20; B60W 2710/18; B60W 2710/20; B60W 2710/06; B60W 2710/08; G01S 17/89

(57) ABSTRACT

A computing system can determine a vehicle action based on determining a free space map based on combining video sensor data and radar sensor data. The computing system can further determine a path polynomial based on combining the free space map and lidar sensor data. The computing system can then operate a vehicle based on the path polynomial.

### BACKGROUND

Vehicles can be equipped to operate in both autonomous and occupant piloted mode. Vehicles can be equipped with computing devices, networks, sensors and controllers to acquire information regarding the vehicle's environment and to operate the vehicle based on the information. Safe and comfortable operation of the vehicle can depend upon acquiring accurate and timely information regarding the vehicle's environment. Vehicle sensors can provide data concerning routes to be traveled and objects to be avoided in the vehicle's environment. Safe and efficient operation of the vehicle can depend upon acquiring accurate and timely information regarding routes and objects in a vehicle's environment while the vehicle is being operated on a roadway.

### BRIEF DESCRIPTION OF THE DRAWINGS

FIG. 1 is a block diagram of an example vehicle.

FIG. 2 is a diagram of an example vehicle including sensors.

FIG. 3 is a diagram of an example B-spline.

FIG. 4 is a diagram of an example B-spline.

FIG. 5 is a diagram of an example sensor field of view.

FIG. 6 is a diagram of an example sensor field of view including stationary objects.

FIG. 7 is a diagram of an example sensor field of view including stationary objects and non-stationary objects.

FIG. 8 is a diagram of an example vehicle map including stationary objects and non-stationary objects.

FIG. 9 is a diagram of an example vehicle map including stationary objects and non-stationary objects.

FIG. 10 is a diagram of an example vehicle map including B-splines.

FIG. 11 is a diagram of an example vehicle map including a free space map.

FIG. 12 is a diagram of an example vehicle map including a free space map.

FIG. 13 is a diagram of an example vehicle map including a free space map.

FIG. 14 is a diagram of an example vehicle map including a free space map.

FIG. 15 is a flowchart diagram of an example process to operate a vehicle with a free space map.

### DETAILED DESCRIPTION

Vehicles can be equipped to operate in both autonomous and occupant piloted mode. By a semi- or fully-autonomous mode, we mean a mode of operation wherein a vehicle can be piloted by a computing device as part of a vehicle information system having sensors and controllers. The vehicle can be occupied or unoccupied, but in either case the vehicle can be piloted without assistance of an occupant. For purposes of this disclosure, an autonomous mode is defined as one in which each of vehicle propulsion (e.g., via a powertrain including an internal combustion engine and/or electric motor), braking, and steering are controlled by one or more vehicle computers; in a semi-autonomous mode the vehicle computer(s) control(s) one or two of vehicle propulsion, braking, and steering. In a non-autonomous vehicle, none of these are controlled by a computer.

A computing device in a vehicle can be programmed to acquire data regarding the external environment of a vehicle and to use the data to determine a path polynomial to be used to operate a vehicle in autonomous or semi-autonomous mode, for example, wherein the computing device can provide information to controllers to operate vehicle on a roadway in traffic including other vehicles. Based on sensor data, a computing device can determine a free space map to permit a vehicle to determine a path polynomial to operate a vehicle with to reach a destination on a roadway in the presence of other vehicles and pedestrians, where a path polynomial is defined as a polynomial function connecting successive locations of a vehicle as it moves from a first location on a roadway to a second location on a roadway, and a free space map is defined as a vehicle-centric map that includes stationary objects including roadways and non-stationary objects including other vehicles and pedestrians, for example.

Disclosed herein is a method, including determining a free space map of an environment around a vehicle by combining video sensor data and radar sensor data, determining a path polynomial by combining the free space map and lidar sensor data, and operating the vehicle with the path polynomial. Combining the video sensor data and the radar sensor data can include projecting video sensor data points and radar sensor data points onto the free space map based on determining a distance and direction from a video sensor or radar sensor, respectively, of the video sensor data points and the radar sensor data points. The free space map is a top-down map of an environment around the vehicle that includes a roadway and one or more other vehicles represented by stationary and non-stationary data points, respectively.

Determining the free space map can further include determining stationary data points and non-stationary data points based on video sensor data points and radar sensor data points. Determining the free space map can further include fitting B-splines to a subset of stationary data points. Determining the path polynomial can further include determining a predicted location with respect to the roadway based on the free space map including non-stationary data points and lidar sensor data. Determining the path polynomial can further include applying upper and lower limits on lateral and longitudinal accelerations. Operating the vehicle with the path polynomial within the free space map while avoiding non-stationary data points can include operating the vehicle on a roadway and avoiding other vehicles. Video sensor data can be acquired by a color video sensor and processed with a video data processor. Radar sensor data can include false alarm data and combining video sensor data with radar sensor data includes detecting false alarm data. Combining the free space map and lidar sensor data includes detecting false alarm data. Combining the free space map and lidar sensor data includes map data. The vehicle can be operated by controlling vehicle steering, braking, and powertrain.

Further disclosed is a computer readable medium, storing program instructions for executing some or all of the above method steps. Further disclosed is a computer programmed for executing some or all of the above method steps, including a computer apparatus, programmed to determining a free space map of an environment around a vehicle by combining video sensor data and radar sensor data, determining a path polynomial by combining the free space map and lidar sensor data, and operating the vehicle with the path polynomial. Combining the video sensor data and the radar sensor data can include projecting video sensor data points and radar sensor data points onto the free space map based on determining a distance and direction from a video sensor or radar sensor, respectively, of the video sensor data points and the radar sensor data points. The free space map is a top-down map of an environment around the vehicle that includes a roadway and one or more other vehicles represented by stationary and non-stationary data points, respectively.

The computer apparatus can be further programmed to determine the free space map including determining stationary data points and non-stationary data points based on video sensor data points and radar sensor data points. Determining the free space map can further include fitting B-splines to a subset of stationary data points. Determining the path polynomial can further include determining a predicted location with respect to the roadway based on the free space map including non-stationary data points and lidar sensor data. Determining the path polynomial can further include applying upper and lower limits on lateral and longitudinal accelerations. Operating the vehicle with the path polynomial within the free space map while avoiding non-stationary data points can include operating the vehicle on a roadway and avoiding other vehicles. Video sensor data can be acquired by a color video sensor and processed with a video data processor. Radar sensor data can include false alarm data and combining video sensor data with radar sensor data includes detecting false alarm data. Combining the free space map and lidar sensor data includes detecting false alarm data. Combining the free space map and lidar sensor data includes map data. The vehicle can be operated by controlling vehicle steering, braking, and powertrain.

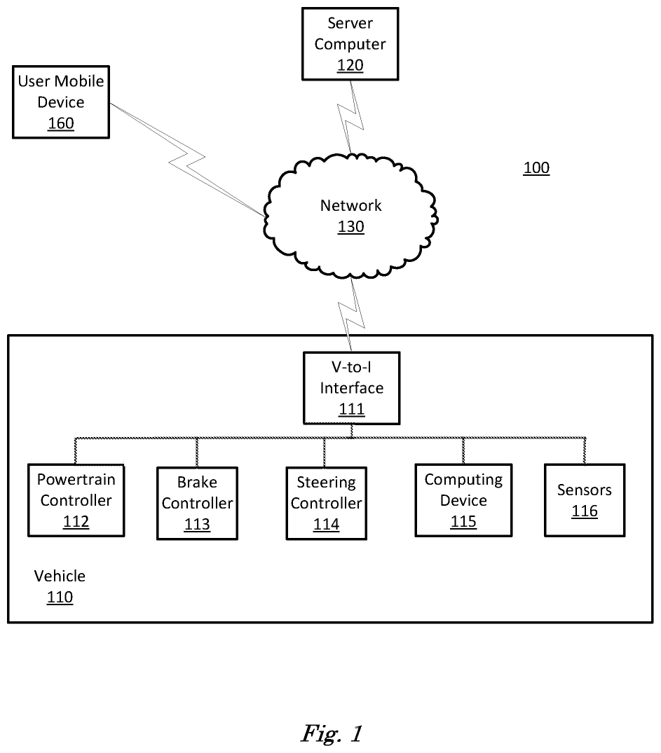

FIG. 1 is a diagram of a traffic infrastructure system 100 that includes a vehicle 110 operable in autonomous (“autonomous” by itself in this disclosure means “fully autonomous”) and occupant piloted (also referred to as non-autonomous) mode. Vehicle 110 also includes one or more computing devices 115 for performing computations for piloting the vehicle 110 during autonomous operation. Computing devices 115 can receive information regarding the operation of the vehicle from sensors 116. The computing device 115 may operate the vehicle 110 in an autonomous mode, a semi-autonomous mode, or a non-autonomous mode. For purposes of this disclosure, an autonomous mode is defined as one in which each of vehicle 110 propulsion, braking, and steering are controlled by the computing device; in a semi-autonomous mode the computing device 115 controls one or two of vehicle's 110 propulsion, braking, and steering; in a non-autonomous mode, a human operator controls the vehicle propulsion, braking, and steering.

The computing device 115 includes a processor and a memory such as are known. Further, the memory includes one or more forms of computer-readable media, and stores instructions executable by the processor for performing various operations, including as disclosed herein. For example, the computing device 115 may include programming to operate one or more of vehicle brakes, propulsion (e.g., control of acceleration in the vehicle 110 by controlling one or more of an internal combustion engine, electric motor, hybrid engine, etc.), steering, climate control, interior and/or exterior lights, etc., as well as to determine whether and when the computing device 115, as opposed to a human operator, is to control such operations.

The computing device 115 may include or be communicatively coupled to, e.g., via a vehicle communications bus as described further below, more than one computing devices, e.g., controllers or the like included in the vehicle 110 for monitoring and/or controlling various vehicle components, e.g., a powertrain controller 112, a brake controller 113, a steering controller 114, etc. The computing device 115 is generally arranged for communications on a vehicle communication network, e.g., including a bus in the vehicle 110 such as a controller area network (CAN) or the like; the vehicle 110 network can additionally or alternatively include wired or wireless communication mechanisms such as are known, e.g., Ethernet or other communication protocols.

Via the vehicle network, the computing device 115 may transmit messages to various devices in the vehicle and/or receive messages from the various devices, e.g., controllers, actuators, sensors, etc., including sensors 116. Alternatively, or additionally, in cases where the computing device 115 actually comprises multiple devices, the vehicle communication network may be used for communications between devices represented as the computing device 115 in this disclosure. Further, as mentioned below, various controllers or sensing elements such as sensors 116 may provide data to the computing device 115 via the vehicle communication network.

In addition, the computing device 115 may be configured for communicating through a vehicle-to-infrastructure (V-to-I) interface 111 with a remote server computer 120, e.g., a cloud server, via a network 130, which, as described below, includes hardware, firmware, and software that permits computing device 115 to communicate with a remote server computer 120 via a network 130 such as wireless Internet (Wi-Fi) or cellular networks. V-to-I interface 111 may accordingly include processors, memory, transceivers, etc., configured to utilize various wired and/or wireless networking technologies, e.g., cellular, BLUETOOTH® and wired and/or wireless packet networks. Computing device 115 may be configured for communicating with other vehicles 110 through V-to-I interface 111 using vehicle-to-vehicle (V-to-V) networks, e.g., according to Dedicated Short Range Communications (DSRC) and/or the like, e.g., formed on an ad hoc basis among nearby vehicles 110 or formed through infrastructure-based networks. The computing device 115 also includes nonvolatile memory such as is known. Computing device 115 can log information by storing the information in nonvolatile memory for later retrieval and transmittal via the vehicle communication network and a vehicle to infrastructure (V-to-I) interface 111 to a server computer 120 or user mobile device 160.

As already mentioned, generally included in instructions stored in the memory and executable by the processor of the computing device 115 is programming for operating one or more vehicle 110 components, e.g., braking, steering, propulsion, etc., without intervention of a human operator. Using data received in the computing device 115, e.g., the sensor data from the sensors 116, the server computer 120, etc., the computing device 115 may make various determinations and/or control various vehicle 110 components and/or operations without a driver to operate the vehicle 110. For example, the computing device 115 may include programming to regulate vehicle 110 operational behaviors (i.e., physical manifestations of vehicle 110 operation) such as speed, acceleration, deceleration, steering, etc., as well as tactical behaviors (i.e., control of operational behaviors typically in a manner intended to achieve safe and efficient traversal of a route) such as a distance between vehicles and/or amount of time between vehicles, lane-change, minimum gap between vehicles, left-turn-across-path minimum, time-to-arrival at a particular location and intersection (without signal) minimum time-to-arrival to cross the intersection.

Controllers, as that term is used herein, include computing devices that typically are programmed to control a specific vehicle subsystem. Examples include a powertrain controller 112, a brake controller 113, and a steering controller 114. A controller may be an electronic control unit (ECU) such as is known, possibly including additional programming as described herein. The controllers may communicatively be connected to and receive instructions from the computing device 115 to actuate the subsystem according to the instructions. For example, the brake controller 113 may receive instructions from the computing device 115 to operate the brakes of the vehicle 110.

The one or more controllers 112, 113, 114 for the vehicle 110 may include known electronic control units (ECUs) or the like including, as non-limiting examples, one or more powertrain controllers 112, one or more brake controllers 113, and one or more steering controllers 114. Each of the controllers 112, 113, 114 may include respective processors and memories and one or more actuators. The controllers 112, 113, 114 may be programmed and connected to a vehicle 110 communications bus, such as a controller area network (CAN) bus or local interconnect network (LIN) bus, to receive instructions from the computer 115 and control actuators based on the instructions.

Sensors 116 may include a variety of devices known to provide data via the vehicle communications bus. For example, a radar fixed to a front bumper (not shown) of the vehicle 110 may provide a distance from the vehicle 110 to a next vehicle in front of the vehicle 110, or a global positioning system (GPS) sensor disposed in the vehicle 110 may provide geographical coordinates of the vehicle 110. The distance(s) provided by the radar and/or other sensors 116 and/or the geographical coordinates provided by the GPS sensor may be used by the computing device 115 to operate the vehicle 110 autonomously or semi-autonomously.

The vehicle 110 is generally a land-based vehicle 110 capable of autonomous and/or semi-autonomous operation and having three or more wheels, e.g., a passenger car, light truck, etc. The vehicle 110 includes one or more sensors 116, the V-to-I interface 111, the computing device 115 and one or more controllers 112, 113, 114. The sensors 116 may collect data related to the vehicle 110 and the environment in which the vehicle 110 is operating. By way of example, and not limitation, sensors 116 may include, e.g., altimeters, cameras, LIDAR, radar, ultrasonic sensors, infrared sensors, pressure sensors, accelerometers, gyroscopes, temperature sensors, pressure sensors, hall sensors, optical sensors, voltage sensors, current sensors, mechanical sensors such as switches, etc. The sensors 116 may be used to sense the environment in which the vehicle 110 is operating, e.g., sensors 116 can detect phenomena such as weather conditions (precipitation, external ambient temperature, etc.), the grade of a road, the location of a road (e.g., using road edges, lane markings, etc.), or locations of target objects such as neighboring vehicles 110. The sensors 116 may further be used to collect data including dynamic vehicle 110 data related to operations of the vehicle 110 such as velocity, yaw rate, steering angle, engine speed, brake pressure, oil pressure, the power level applied to controllers 112, 113, 114 in the vehicle 110, connectivity between components, and accurate and timely performance of components of the vehicle 110.

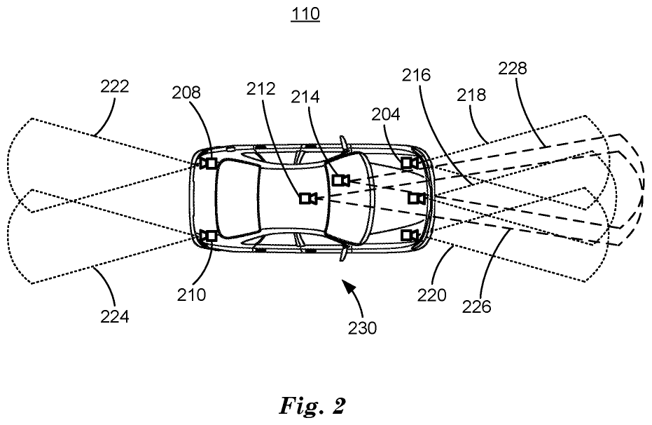

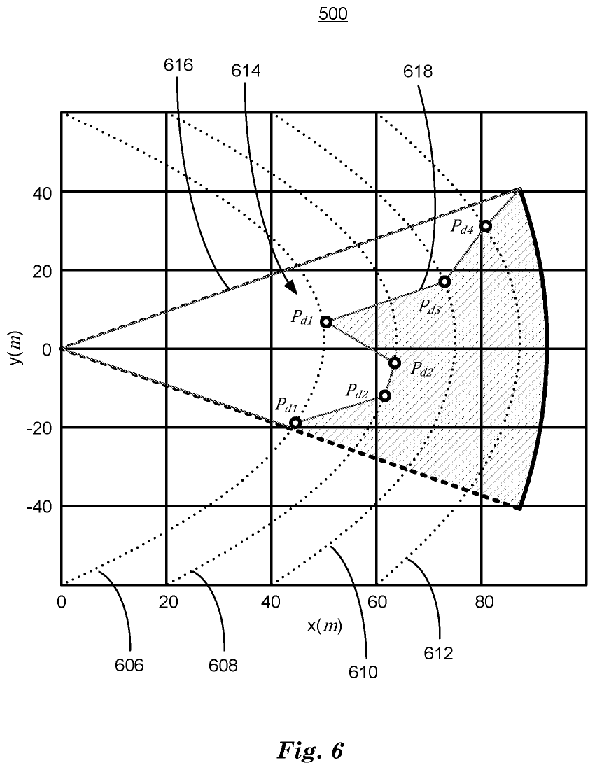

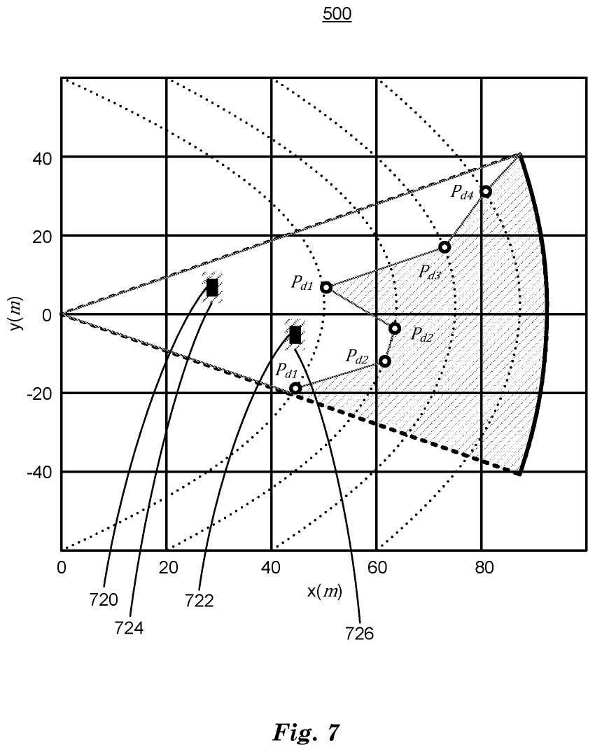

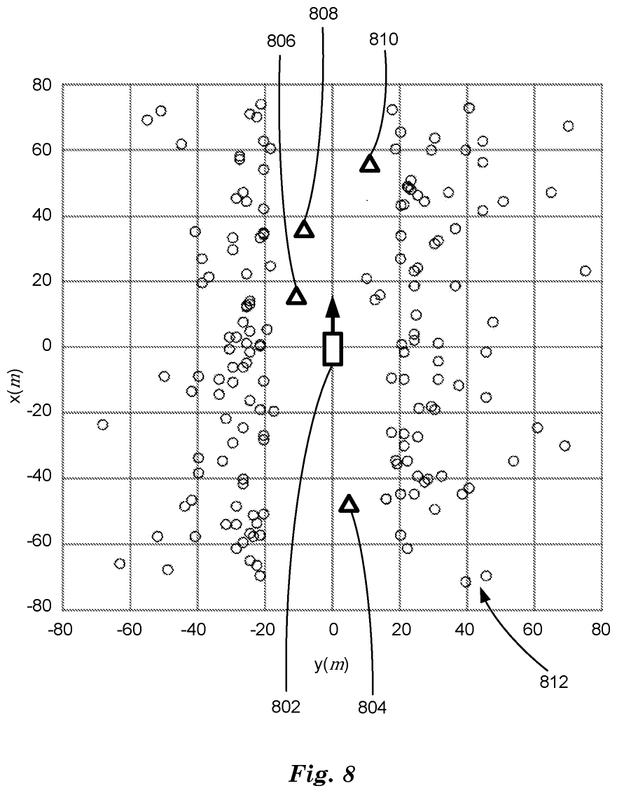

FIG. 2 is a diagram of an example vehicle 110 including sensors 116 including a front radar sensor 202, left front radar sensor 204, right front radar sensor 206, left rear radar sensor 208, right rear radar sensor 210 (collectively radar sensors 230), lidar sensor 212 and video sensor 214 and their respective fields of view 216, 218, 220, 222, 224 (dotted lines) and 226, 228 (dashed lines). A field of view 216, 218, 220, 222, 224, 226, 228 is a 2D view of a 3D volume of space within which a sensor 116 can acquire data. Radar sensors 230 operate by transmitting pulses at microwave frequencies and measuring the microwave energy reflected by surfaces in the environment to determine range and doppler motion. Computing device 115 can be programmed to determine stationary objects and non-stationary objects in radar sensor 230 data. Stationary objects include roadways, curbs, pillars, abutments, barriers, traffic signs, etc. and non-stationary objects include other vehicles and pedestrians, etc. Detection of objects in a field of view 216, 218, 220, 222, 224 will be discussed below in relation to FIGS. 6 and 7. Processing detected stationary objects and non-stationary objects to determine a free space map with B-splines will be discussed below in relation to FIGS. 8-13. A lidar sensor 212 emits pulses of infrared (IR) light and measures the reflected IR energy reflected by surfaces in the environment in a field of view 226 to determine range. Computing device 115 can be programmed to determine stationary and non-stationary objects in lidar sensor data. A video sensor 214 can acquire video data from ambient light reflected by the environment of the vehicle within a field of view 228. A video sensor 214 can include a processor and memory programmed to detect stationary and non-stationary objects in the field of view.

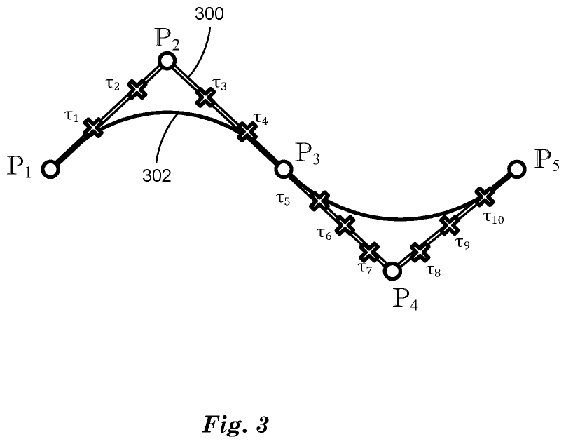

FIG. 3 is a diagram of an example B-spline 300. A B-spline 300 is a polynomial function that can approximate a curve 302. A B-spline 300 is a set of joined polynomial functions that approximate a curve 302 defined by any function by minimizing a distance metric, for example Euclidian distance in 2D space, between B-spline 300 knots, represented by X's marked τ₁ . . . τ₁₀ located on the polynomial functions that are joined at control points [ [symbol] ᵢ]ᵢ₌₁⁵, and a point on the curve 302, for example. A B-Spline can be multi-dimensional with accompanying increases in computational requirements. A knot can be a multi-dimensional vehicle state vector including location, pose and accelerations, and the distance metric can be determined by solving sets of linear equations based on the vehicle state vectors. A B-spline is defined by control points where control points [ [symbol] ᵢ]ᵢ₌₁⁵ are located based on having a predetermined number of knots (X's), for example 2 or 3, between each pair of control points [ [symbol] ᵢ]ᵢ₌₁⁵, joined by a polynomial function.

The selection of control points [ [symbol] [symbol] ᵢ]ᵢ₌₁⁵ is based on dividing the knots of a B-spline 300 into polynomial segments with about the same number of knots per segment, for example two or three knots. The first control point [ [symbol] ᵢ]ᵢ₌₁⁵ is selected to be at the origin of the curve 302. The second control point [ [symbol] ᵢ]ᵢ₌₁⁵ is selected to be two or three knots away, in a direction that minimizes the distance between the knots and the curve 302. The next control point [ [symbol] ᵢ]ᵢ₌₁⁵ is selected to be two or three knots away from the second control point [ [symbol] ᵢ]ᵢ₌₁⁵ in a direction that minimizes the distance between the curve 302 and the knots, and so forth until the last control point [ [symbol] ᵢ]ᵢ₌₁⁵ is selected to match the end of curve 302. The selection of the number and location of knots on polynomial functions can be based on a user input number of samples per second and the speed of vehicle 110, for example, wherein a vehicle speed divided by the sample rate yields the distance between adjacent knots on the polynomial function. In example B-spline 300 the polynomial functions are of degree one (straight lines). Higher order polynomial functions can also be of degree two (parabolic), three (cubic) or more.

The movement of any control point [ [symbol] ᵢ]ᵢ₌₁⁵ will affect the B-spline and the effect can be on the entire B-spline (global effect) or in a certain part of the B-spline (local effect). A benefit of using a B-spline is its local controllability. Each segment of the curve between the control points [ [symbol] ᵢ]ᵢ₌₁⁵ is divided into smaller segments by the knots. The total number of knots is always greater than the total number of control points [ [symbol] ᵢ]ᵢ₌₁⁵. Adding or removing knots using appropriate control point movement can more closely replicate curve 302, which is suitable for implementing filtering algorithms using splines. Also, a higher order (3 or more) B-spline 300 tends to be smooth and maintains the continuity of the curve, where the order of a B-spline 300 is the order of the polynomial function, e.g. linear, parabolic or cubic or 1^{st}, 2^{nd}, or 3^{rd} order, for example.

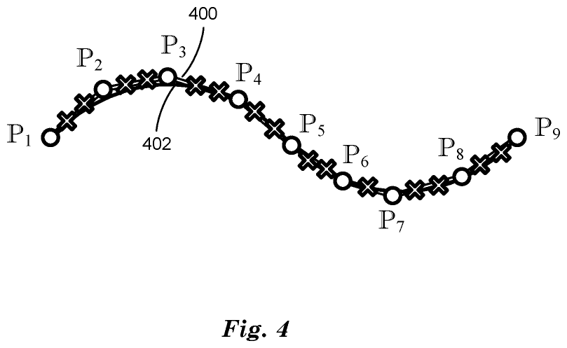

FIG. 4 is a diagram of a B-spline 400 (double line). A B-spline 400 can approximate a curve 402 more closely than B-spline 300 by adding more control points [ [symbol] ᵢ]ᵢ₌₁⁹ and knots, marked by “X” on the B-spline segments between control points [ [symbol] ᵢ]ᵢ₌₁⁹. With increasing number of knots, the B-spline 400 converges to the curve 402. A p-th order B-spline curve C(x) of a variable x (e.g., multitarget state) is defined as

C(x)=Σᵢ₌₁ⁿ^{ₛ} [symbol] ᵢB_{i,p,t}(x) 2≤p≤nₛ (1)

where [symbol] ᵢ is the i-th control point and nₛ is the total number of control points. The B-spline blending functions or basis functions are denoted by B_{i,p,t}(x). Blending functions are polynomials of degree p−1. The order p can be chosen from 2
to nₛ and the continuity of the curve can be kept by selecting p≥3. The knot denoted by t is a 1×τ vector and t is a non-decreasing sequence of real numbers, where t={t₁ . . . , t_{τ}}, i.e., tᵢ≤tᵢ₊₁, i=1, . . . , τ. The knot vector relates the parameter x to the control points. The shape of any curve can be controlled by adjusting the locations of the control points. The i-th basis function can be defined as

$${B}_{i , p , t} ( x ) = \frac{( x - {t}_{i} ) {B}_{i , p - 1} ( x )}{{t}_{i + p - 1} - {t}_{i}} + \frac{( {t}_{i + p - 1} - x ) {B}_{i - 1 , p - 1} ( x )}{{t}_{i + p} - {t}_{i + 1}} \qquad ( 2 )$$

where, tᵢ≤x≤tᵢ₊ₚ and

$${B}_{i , p , t} ( x ) = \{ \begin{matrix}1 & if {t}_{i} \leq x \leq {t}_{i + 1} \\ 0 & otherwise\end{matrix} , \qquad ( 3 )$$

where variables tᵢ in (2) denote a knot vector. The basis function B_{i,p,t}(x) is non-zero in the interval [tᵢ, tᵢ₊ₚ]. The basis function B_{i,p} can have the form 0/0 and assume 0/0=0. For any value of the parameter, x, the sum of the basis functions is one, i.e.,

Σᵢ₌₁ⁿ^{ₛ}B_{i,p}(x)=1 (4)

Unidimensional splines can be extended to multidimensional ones through the use of tensor product spline construction.

For a given basic sequence of B-splines {B_{i,p,t}}ᵢ₌₁ⁿ^{ₛ} and strictly increasing sequence of data series {xⱼ}ᵢ₌₁ⁿ^{ₛ} the B-spline interpolation function ĉ(x) can be written as

ĉ(x)=Σᵢ₌₁ⁿ^{ₛ} [symbol] ᵢB_{i,p,t}(x) (5)

where ĉ(x) agrees with function c(x) at all xⱼ if and only if

Σᵢ₌₁ⁿ^{ₛ} [symbol] ᵢB_{i,p,t}(xⱼ)=c(xⱼ), for j=1, . . . ,nₛ (6)

Equation (6) is a linear system of nₛ equations with nₛ unknown values of [symbol] ᵢ and the i-th row and j-th column of the coefficient matrix equals B_{i,p,t}(xⱼ), which means that the spline interpolation function can be found by solving a set of linear system equations. The coefficient matrix can be verified for invertibility using the Schoenberg-Whitney theorem. The Schoenberg-Whitney theorem can be described as follows: Let t be a knot vector, p and n be integers such that n>p>0, and suppose x is strictly increasing with n+1 elements. The matrix L=Σᵢ₌₁ⁿ^{ₛ} [symbol] ᵢB_{i,p,t}(xⱼ) from (6) is invertible if and only if Σᵢ₌₁ⁿ^{ₛ} [symbol] ᵢB_{i,p,t}(xⱼ)≠0, i=0, . . . , n, i.e., if and only if tᵢ<xᵢ<tᵢ₊ₚ₊₁, for all i.

The B-spline transformation can be applied to single and multidimensional statistical functions, e.g., a probability density function and a probability hypothesis density function, without any assumption to account for noise. The B-spline transformation can be derived using the spline approximation curve (SAC) or the spline interpolation curve (SIC) techniques. The difference between these two spline transformations is that the SAC does not necessarily pass through all control points but must go through the first and the last ones. In contrast, the SIC must pass through all control points. The example B-spline transformation discussed herein uses the SIC implementation. B-spline-based target tracking can handle a continuous state space, makes no special assumption on signal noise, and is able accurately approximate arbitrary probability density or probability hypothesis density surfaces. In most tracking algorithms during the update stage, the states are updated, but in B-spline based target tracking only the knots are updated.

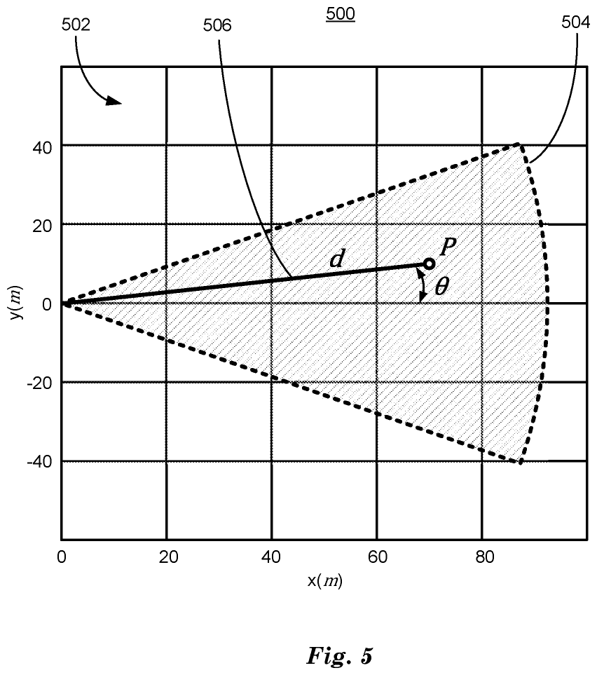

FIG. 5 is a diagram of an example occupancy grid map 500. Occupancy grid map 500 measures distances from a vehicle sensor 116 at location 0,0 on the occupancy grid map 500 measured in meters in x and y directions from the sensor 116. Occupancy grid map 500 measures distances from a point on the front of vehicle 110 assumed to be at location 0,0 on the occupancy grid map 500 in meters in x and y directions in grid cells 502 from the sensor 116. Occupancy grid map 500 is a mapping technique for performing free space analysis (FSA). FSA is a process for determining locations where it is possible for a vehicle 110 to move within a local environment without incurring a collision or near-collision with a vehicle or pedestrian. An occupancy grid map 500 is a two-dimensional array of grid cells 502 that model occupancy evidence (i.e., data showing objects and/or environmental features) of the environment around the vehicle. The resolution of the occupancy grid map 500 depends on the grid cell 502 dimensions. A drawback of a higher resolution map is the increase in complexity because the grid cells must be increased in two dimensions. Each cell probability of occupancy is updated during the observation update process.

Occupancy grid map 500 assumes a vehicle 110 is traveling in the x direction and includes a sensor 116. A field of view 504 for a sensor 116, for example a radar sensor 230, illustrates the 3D volume within which the radar sensor 230 can acquire range data 506 from an environment local to a vehicle 110, projected onto a 2D plane parallel with a roadway upon which the vehicle 110 is traveling, for example. Range data 506 includes a range or distance d at an angle θ from a sensor 116 at point 0,0 to a data point indicated by an open circle having a probability of detection P, where the probability of detection P is a probability that a radar sensor 230 will correctly detect a stationary object, where a stationary object is a detected surface that is not moving with respect to the local environment and is based on the range d of the data point from sensor 116.

Probability of detection P can be determined empirically by detecting a plurality of surfaces with measured distances from sensor 116 a plurality of times and processing the results to determine probability distributions, for example. Probability of detection P can also be determined empirically by comparing a plurality of measurements with ground truth that includes lidar sensor data. Ground truth is a reference measurement of a sensor data value determined independently from the sensor. For example, calibrated lidar sensor data can be used as ground truth to calibrate radar sensor data. Calibrated lidar sensor data means lidar sensor data that has been compared to physical measurements of the same surfaces, for example. Occupancy grid map 500 can assign the probability P to the grid cell 502 occupied by the open circle as a probability that the grid cell 502 is occupied.

FIG. 6 is a diagram of another example occupancy grid map 500. Radar sensor 230 can detect stationary objects 614 (open circles) with a distance d dependent probability P_{d}_{ₙ} (n=1, . . . , N), where N a number of equidistant range lines 606, 608, 610, 612 (dotted lines). Probability P_{d}_{ₙ} is the distance d dependent empirically determined probability of detection for stationary objects 614 in a field of view 504. Occupancy grid map 600 includes equidistant range lines 606, 608, 610, 612 that each indicate constant range from radar sensor 230 at location 0,0. P_{d}_{ₙ} decreases with increasing range d from location 0,0 but over a small range remains the same regardless of angle θ. The stationary objects 614 can be connected to divide the field of view 604 into free grid cells 616 (unshaded) and unknown grid cells 618 (shaded) by connecting each stationary object 614 to the next stationary object 618 with respect to the location 0,0 starting at the bottom and moving in a counter-clockwise fashion, for example.

FIG. 7 is a diagram of yet another example occupancy grid map 500, including non-stationary objects 720, 722. Non-stationary objects 720 can be determined by a radar sensor 230, for example, based on doppler returns. Because vehicle 110 can be moving, computing device 115 can subtract the vehicle's velocity from doppler radar return data to determine surfaces that are moving with respect to a background and thereby determine non-stationary objects 720, 722. Non-stationary objects can include vehicles and pedestrians, for example. Non-stationary object 720, 722 detection can be used as input to non-linear filters to form tracks, to track obstacles in time.

Tracks are successive locations for a non-stationary object 720, 722 detected and identified at successive time intervals and joined together to form a polynomial path. The nonlinear filter estimates a state including estimates for location, direction and speed for a non-stationary object based on the polynomial path that can include covariances for uncertainties in location, direction and speed. Although non-stationary objects 720, 722 are determined without including these uncertainties, they can be included in occupancy grid map 700 by determining unknown space 724, 726 around each non-stationary object 720, 722. Using empirically determined standard deviations of covariances σₓ and σ_{y} of uncertainties of x and y dimensions of non-stationary objects 720, 722, we can form unknown space 724, 726 (shaded) around each non-stationary object 720, 722, respectively proportional to the standard deviations of covariances σₓ and σ_{y}. Standard deviations of covariances σₓ and σ_{y} can be empirically determined by measuring a plurality of non-stationary objects 720, 722 along with acquiring ground truth regarding the non-stationary objects and processing the data to determine standard deviations of covariances σₓ and σ_{y} of uncertainties in x and y dimensions of non-stationary objects 720, 722. Ground truth can be acquired with lidar sensors, for example.

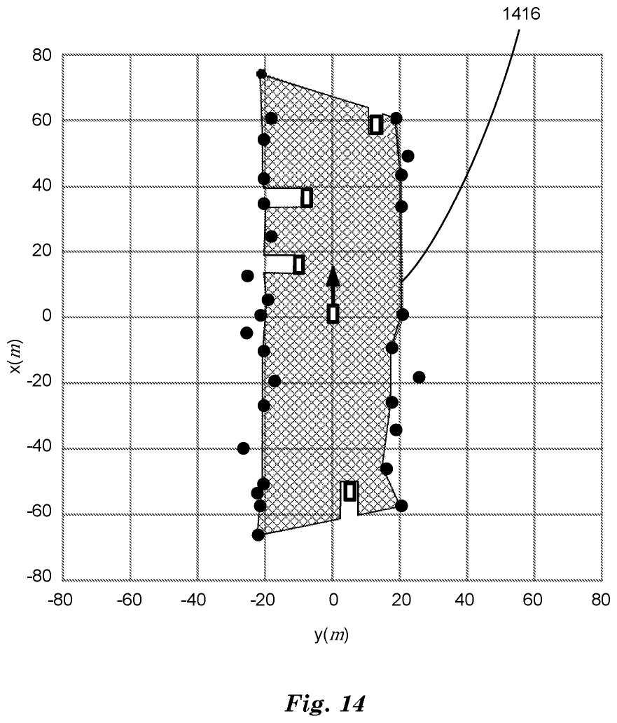

FIG. 8 is a diagram of an example free space map 800 including a vehicle icon 802, which indicates the location, size, and direction of a vehicle 110 in free space map 800. A free space map 800 is a model of the environment around the vehicle, where the location of vehicle icon 802 is at location 0,0 in the free space map 800 coordinate system. Creating an occupancy grid map 500 is one method for creating the environment model, but herein a technique is discussed that creates a model of the environment around a vehicle 110 with B-splines. The B-spline environment model is used to create an output free space region 1416 (see FIG. 14) in free space map 800. In order to maintain continuity in the output free space region 1416, a third order B-spline is used. Free space map 800 assumes a vehicle 110 with radar sensors 230 directed in a longitudinal direction with respect to the vehicle as discussed in relation to FIG. 1.

The measurements are observed with respect to a coordinate system based on the vehicle, a vehicle coordinate system (VCS). The VCS is a right-handed coordinate system, where x-axis (longitudinal), y-axis (lateral) and z-axis (vertical) represent imaginary lines pointing in front of vehicle 110, to the right of vehicle 110 and downward from vehicle 110, respectively. The distance between the front middle of vehicle 110 and a stationary object 812 or non-stationary object 804, 806, 808, 810 is the range. Using the right-hand rule and rotation about z-axis we can calculate a heading angle referred to as the VCS heading. The clockwise deviations from the x-axis are positive VCS heading angles. Free space map 800 includes a vehicle icon 802 that includes an arrow with a length proportional to vehicle speed and direction equal to VCS heading. Free space map 800 includes non-stationary objects 804, 806, 808, 810 (triangles) and stationary objects 812 (open circles). Stationary objects 812 include false alarms, which are spurious radar sensor data points, i.e., that do not correspond to a physical object in the environment.

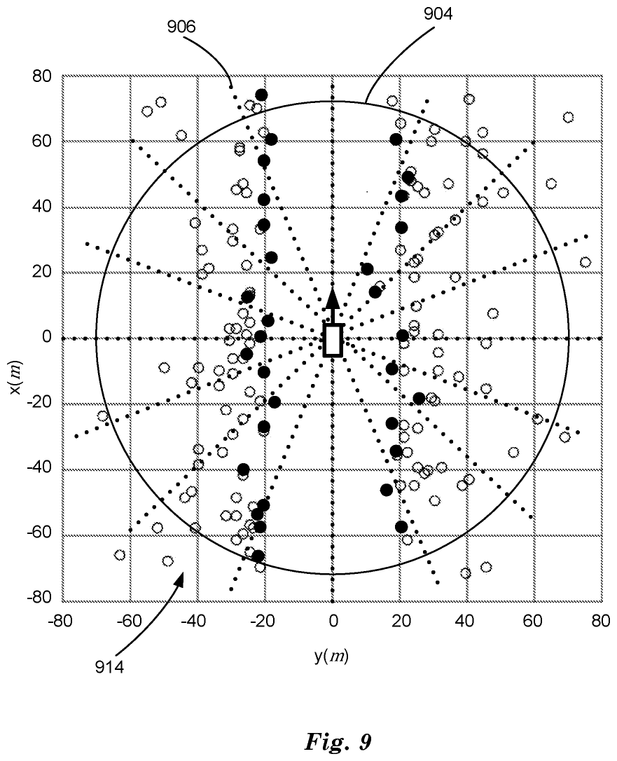

FIG. 9 is a diagram of an example free space map 800. The observed stationary objects 812 are rejected below and above user input ranges, e.g. data points that are too close or too far to be reliably measured are eliminated. Stationary objects 812 (open circles) are isolated from non-stationary objects and are used to create a lower boundary of a free space. A technique as shown in FIG. 9 is used to go around clockwise, illustrated by the circle 904, with respect to the VCS heading of the vehicle icon 802 beginning at the top of free space map 800 and select the stationary object 812 with the shortest range for a specific angle, illustrated by dotted lines 906. Repeat these stationary object 812 selections for a plurality of angles over 360 degrees to determine selected stationary objects 914 (filled circles).

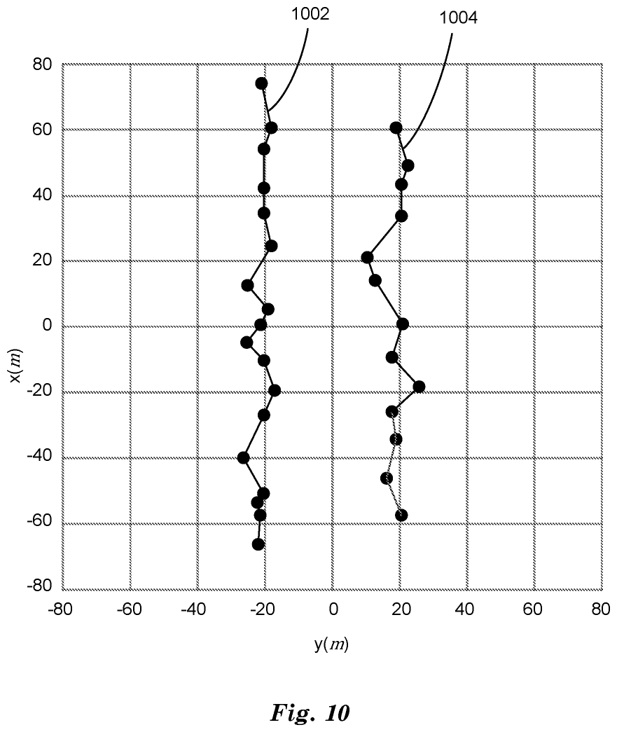

FIG. 10 is a diagram of a free space map 800 including selected stationary objects 914 (filled circles). Selected stationary objects 914 are input as control points to a process that determines left B-spline 1002 and right B-spline 1004 based on equations (1)-(6), above. The process begins by scanning free space map 800 to find unprocessed selected stationary objects 914. Free space map 800 can be scanned in any order as long as the scan covers the entire free space map 800, for example in raster scan order, where rows are scanned before columns. When an unprocessed selected stationary object 914 is found, it is processed by connecting the found selected stationary object 914 with the closest unprocessed selected stationary object 914 as measured in Euclidian distance on the free space map 900. The found selected stationary object 914 and the closest unprocessed selected stationary object 914 can be connected by assuming each is a control point [symbol] ᵢ of a B-spline with knots distributed along lines connecting the control points [symbol] ᵢ, and calculating B-spline interpolation functions for third order B-splines according to equation (6) above, to determine left and right B-splines 1002, 1004 based on the selected stationary objects 914 as control points [symbol] ᵢ. As each selected stationary object 914 is processed to add the next closest unprocessed stationary object 914, left and right B-splines 1002, 1004 are formed. For real-time mapping applications, like determining free space for a vehicle 110, computational complexity can become a problem. Occupancy grids 600 require a lot of time to update each cell probability and also for the segmentation between free and non-free spaces. In order to reduce computational complexity, left and right B-splines 1002, 1004 can be determined based on selected stationary objects 914.

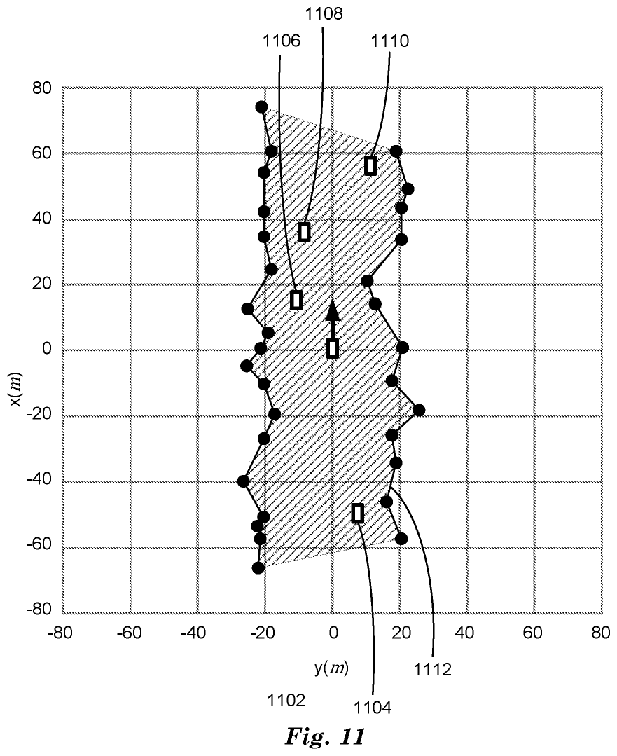

FIG. 11 is a diagram of a free space map 800 including selected stationary objects 914 (filled circles), left and right B-splines 1002, 1004, a vehicle icon 802 and non-stationary object icons 1104, 1106, 1108, 1110. Computing device 115 can process non-stationary object 806, 808, 810, 802 data over time to create tracks in a free space map 800 to determine a location, speed and direction for each. Based on the location, speed, and direction, computing device 115 can identify the tracks as vehicles and assign non-stationary object icons 1104, 1106, 1108, 1110 to the determined locations in free space map 800. Computing device 115 can also determine a first free space region 1112 (right-diagonal shaded), by determining a minimal enclosed region that includes left and right B-splines 1002, 1004 by performing convex closure operations on subsets of selected stationary objects 914 to determine minimally enclosing polygons and combining the resulting enclosing polygons. The first free space region 1112 is a first estimate of a free space region for operating a vehicle 110 safely and reliably, where safe and reliable operation includes operating a vehicle 110 to travel to a determined location without a collision or near-collision with another vehicle or pedestrian.

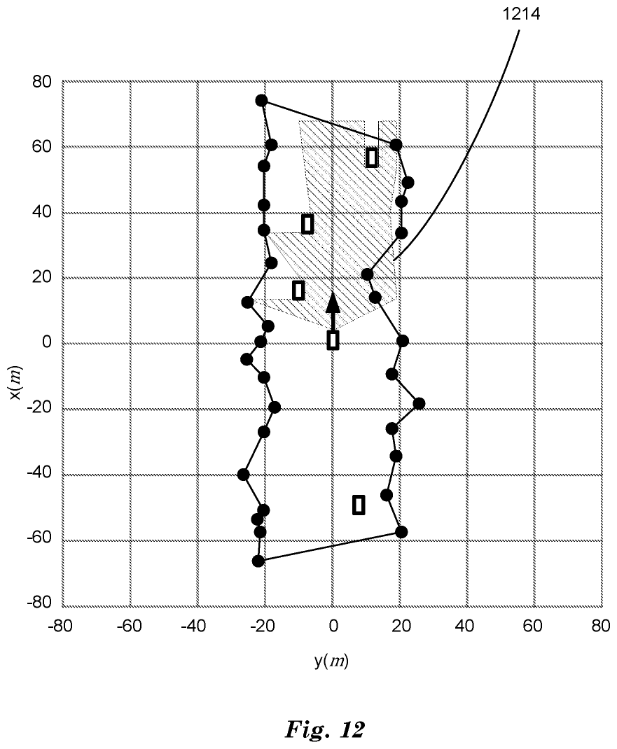

FIG. 12 is a diagram of an example free space map 800 including selected stationary objects 914, left B-spline 1002, right B-spline 1004, vehicle icon 802, non-stationary object icons 1104, 1106, 1108, 1110, and image-based free space region 1212 (left-diagonal shading). Image-based free space region 1214 is a region bounded by B-splines based on output from a video-based processor that acquires color video data and processes the color video data to determine roadways and obstacles and plan a path for a vehicle 110 to operate upon. For example, Advanced Driver Assistance System (ADAS) (Mobileye, Jerusalem, Israel) is a video sensor and processor that can be fixed at a position similar to a rear-view mirror on a vehicle 110 and communicate information regarding locations of roadways and stationary and non-stationary objects to a computing device 115 in vehicle 110. Computing device 115 can use techniques as described above in relation to FIG. 11 to determine an image-based free space region 1214 based locations of stationary and non-stationary objects output from a video-based processor like ADAS.

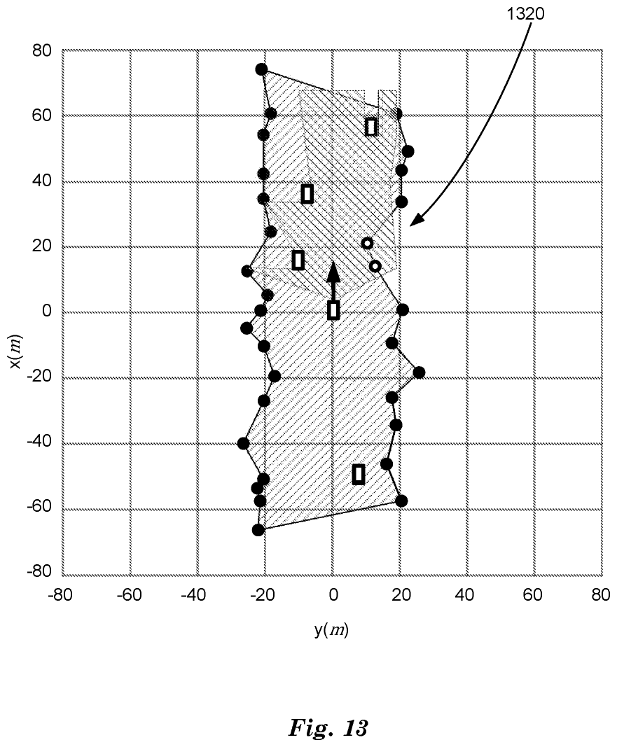

FIG. 13 is a diagram of an example free space map 800 including selected stationary objects 914, left B-spline 1002, right B-spline 1004, vehicle icon 802, non-stationary object icons 1104, 1106, 1108, 1110, image-based free space region 1214 (left-diagonal shading) and first free space region 1112 (right-diagonal shading). Free space map 800 includes false alarm objects 1320 (open circles). False alarm objects 1320 are selected stationary objects 914 that are determined to be false alarms, where the probability of an object being at the location indicated by the selected stationary object 914 is determined to be low, i.e., below a predetermined threshold, based on conflicting information from image-based free space region 1214. In this example, first free space region 1112 indicates that false alarm objects 1320 are selected stationary objects 914, while image-based free space region 1214 indicates that the area of the local environment occupied by the false alarm objects 1320 is free space. Because the image-based free space region 1214 can output information regarding the probability of an area of the local environment being free space, and computing device 115 has calculated covariances for first free space region 1112 as discussed above in relation to FIG. 7, based on probabilities computing device 115 can determine information from which free space region 1112, 1214 to use.

FIG. 14 is a diagram of an example free space map 800 including selected stationary objects 914, left B-spline 1002, right B-spline 1004, vehicle icon 802, non-stationary object icons 1104, 1106, 1108, 1110, and an output free space region 1416 (crosshatch shading). Output free space region 1416 is formed by combining image-based free space region 1214, first free space region 1112, and verifying the combination with lidar data. Output free space region 1416 can be verified by comparing output free space region 1416 to lidar sensor data. Since lidar sensor data is range data acquired independently from radar and image sensor data, lidar sensor data is ground truth with respect to output free space region 1416. Lidar sensor data can be used to confirm segmentation of free space map 800 by comparing range output from a lidar sensor with ranges determined for edges of output free space region 1416 and ranges from vehicle 110 to non-stationary object icons 1104, 1106, 1108, 1110, wherein ranges are determined with respect to front of vehicle 110. Lidar sensor range should be greater than or equal to range determined from edges of output free space region 1416 or non-stationary object icons 1104, 1106, 1108, 1110. When the range reported by lidar sensor for a point in free space map 800 is greater than the range determined by the boundary of the output free space map 1416, computing device 115 can select the lidar data point range.

Output free space region 1416 can also be improved by comparing the output free space map 1416 to map data, for example GOOGLE™ maps, stored at computing device 115 memory or downloaded from a server computer 120 via V-to-I interface 111. Map data can describe the roadway and combined with information from sensors 116 including GPS sensors and accelerometer-based inertial sensors regarding the location, direction and speed of vehicle 110, can improve the description of free space included in output free space region 1416. The combined image-based free space region 1214, first free space region 1112, and lidar data can be processed by computing device to segment free space map 800 into free space, illustrated by output free space region 1416, occupied space, illustrated by vehicle icon 802 and non-stationary object icons 1104, 1106, 1108, 1110, and unknown space, illustrated by white space surrounding output free space region 1214 and in white space “shadowed” from vehicle 110 sensors 116 by non-stationary object icons 1104, 1106, 1108, 1110, for example.

Free space map 800 can be used by computing device 115 to operate vehicle 110 by determining a path polynomial upon which to operate vehicle 110 to travel from a current location to a destination location within output free space region 1416 that maintains vehicle 110 within output free space region 1416 while avoiding non-stationary object icons 1104, 1106, 1108, 1110. A path polynomial is a polynomial function of degree three or less that describes the motion of a vehicle 110 on a roadway. Motion of a vehicle on a roadway is described by a multi-dimensional state vector that includes vehicle location, orientation speed and acceleration including positions in x, y, z, yaw, pitch, roll, yaw rate, pitch rate, roll rate, heading velocity and heading acceleration that can be determined by fitting a polynomial function to successive 2D locations included in vehicle motion vector with respect to a roadway surface, for example. The polynomial function can be determined by computing device 115 by predicting next locations for vehicle 110 based on the current vehicle state vector by requiring that vehicle 110 stay within upper and lower limits of lateral and longitudinal acceleration while traveling along the path polynomial to a destination location within output free space region 1416, for example. Computing device 115 can determine a path polynomial that stays within an output free space region 1416, avoids collisions and near-collisions with vehicles and pedestrians by maintaining a user input minimum distance from non-stationary object icons 1104, 1106, 1108, 1110, and reaches a destination location with a vehicle state vector in a desired state.

Computing device 115 operates vehicle 110 on path polynomial by determining commands to send to controllers 112, 113, 114 to control vehicle 110 powertrain, steering and brakes to cause vehicle 110 to travel along path polynomial. Computing device 115 can determine commands to send to controllers 112, 113, 114 by determining the commands that will cause vehicle 110 motion equal to predicted vehicle state vectors included in path polynomial. Computing device 115 can determine probabilities associated with predicted locations of non-stationary object icons 1104, 1106, 1108, 1110 based on user input parameters and map the information on free space map 800, for example. Determining free space map 800 including output free space region 1416 based on B-splines as described above in relation to FIGS. 8-14 improves operation of vehicle 110 based on a path polynomial by determining an output free space region 1416 with fewer false alarms, higher accuracy, and less computation than techniques based on an occupancy grid map 500.

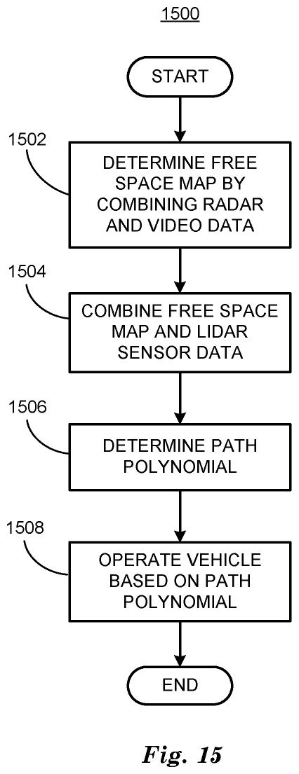

FIG. 15 is a diagram of a flowchart, described in relation to FIGS. 1-14, of a process 1500 for operating a vehicle based on a free space map 800. Process 1500 can be implemented by a processor of computing device 115, taking as input information from sensors 116, and executing commands and sending control signals via controllers 112, 113, 114, for example. Process 1500 includes multiple blocks taken in the illustrated order. Process 1500 also could include implementations including fewer blocks and/or the blocks taken in different orders.

Process 1500 begins at block 1502, in which a computing device 115 included in a vehicle 110 can determine a free space map 800 including an output free space region 1416 by combining data from radar sensors 230 and video-based image sensors. The data from radar sensors 230 is divided into stationary objects 812 and non-stationary objects 804, 806, 808, 810. The stationary objects 812 are processed by computing device 115 to become selected stationary objects 914, which are then converted to B-splines and joined to become a first free space region 1112. The first free space region 1112 is combined with image-based free space region 1214 produced by processing video data, and map data to produce an output free space region 1416 included in a free space map 800.

At block 1504 computing device 115 combines free space map 800 including output free space region 1416 with ground truth lidar data. Lidar data includes range data for surfaces that reflect infrared radiation output by a lidar sensor in the local environment around a vehicle 110. Lidar data can be compared to output free space region 1416 to determine if any objects as indicated by lidar data are included in the free space region 1416. Disagreement between lidar data and output free space region 1416 could indicate a system malfunction indicating unreliable data. When computing device 115 becomes aware of unreliable data, computing device 115 can respond by commanding vehicle 110 to slow to a stop and park, for example.

At block 1506 computing device can determine a path polynomial based on the combined output free space region 1416 and lidar data. Combining lidar ground truth data with an output free space region 1416 can improve the accuracy of the output free space region 1416 by determining false alarms and thereby making the output free space region 1416 more closely match map data, for example. The path polynomial can be determined by computing device based on combined free space region 1416 and lidar data as discussed above in relation to FIG. 14, to permit vehicle 110 to operate from a current location in output free space region 1416 to a destination location in output free space region 1416 while maintaining vehicle 110 lateral and longitudinal accelerations within upper and lower limits and avoiding collisions or near collisions with non-stationary objects 804, 806, 808, 810.

At block 1508 computing device output commands to controllers 112, 113, 114 to control vehicle 110 powertrain, steering and brakes to operate vehicle 110 along path polynomial. Vehicle 110 can be traveling on a roadway at a high rate of speed at the beginning of path polynomial and be traveling at a high rate of speed when it reaches the destination location. Because determining path polynomials can be performed efficiently using B-splines, computing device 115 will have determined a new path polynomial prior to the time the vehicle 110 reaches the destination location, which permits vehicle 110 to travel from path polynomial to path polynomial smoothly without altering speed or direction abruptly. Following block 1506 process 1500 ends.

Computing devices such as those discussed herein generally each include commands executable by one or more computing devices such as those identified above, and for carrying out blocks or steps of processes described above. For example, process blocks discussed above may be embodied as computer-executable commands.

Computer-executable commands may be compiled or interpreted from computer programs created using a variety of programming languages and/or technologies, including, without limitation, and either alone or in combination, Java™, C, C++, Visual Basic, Java Script, Perl, HTML, etc. In general, a processor (e.g., a microprocessor) receives commands, e.g., from a memory, a computer-readable medium, etc., and executes these commands, thereby performing one or more processes, including one or more of the processes described herein. Such commands and other data may be stored in files and transmitted using a variety of computer-readable media. A file in a computing device is generally a collection of data stored on a computer readable medium, such as a storage medium, a random access memory, etc.

A computer-readable medium includes any medium that participates in providing data (e.g., commands), which may be read by a computer. Such a medium may take many forms, including, but not limited to, non-volatile media, volatile media, etc. Non-volatile media include, for example, optical or magnetic disks and other persistent memory. Volatile media include dynamic random access memory (DRAM), which typically constitutes a main memory. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

All terms used in the claims are intended to be given their plain and ordinary meanings as understood by those skilled in the art unless an explicit indication to the contrary in made herein. In particular, use of the singular articles such as “a,” “the,” “said,” etc. should be read to recite one or more of the indicated elements unless a claim recites an explicit limitation to the contrary.

The term “exemplary” is used herein in the sense of signifying an example, e.g., a reference to an “exemplary widget” should be read as simply referring to an example of a widget.

The adverb “approximately” modifying a value or result means that a shape, structure, measurement, value, determination, calculation, etc. may deviate from an exactly described geometry, distance, measurement, value, determination, calculation, etc., because of imperfections in materials, machining, manufacturing, sensor measurements, computations, processing time, communications time, etc.

In the drawings, the same reference numbers indicate the same elements. Further, some or all of these elements could be changed. With regard to the media, processes, systems, methods, etc. described herein, it should be understood that, although the steps or blocks of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claimed invention.

We claim:

1. A method, comprising:
determining a free space map of an environment around a vehicle by combining video sensor data and radar sensor data;
determining a path polynomial by combining the free space map and lidar sensor data; and
operating the vehicle with the path polynomial.

2. The method of claim 1, wherein combining the video sensor data and the radar sensor data includes projecting video sensor data points and radar sensor data points onto the free space map based on determining a distance and direction from a video sensor or radar sensor, respectively, of the video sensor data points and the radar sensor data points.

3. The method of claim 2, wherein the free space map is a top-down map of an environment around the vehicle that includes a roadway and one or more other vehicles represented by stationary and non-stationary data points, respectively.

4. The method of claim 3, wherein determining the free space map further includes determining stationary data points and non-stationary data points based on video sensor data points and radar sensor data points.

5. The method of claim 4, wherein determining the free space map further includes fitting B-splines to a subset of stationary data points.

6. The method of claim 5, wherein determining the path polynomial further includes determining a predicted location with respect to the roadway based on the free space map including non-stationary data points and lidar sensor data.

7. The method of claim 6, wherein determining the path polynomial further includes applying upper and lower limits on lateral and longitudinal accelerations.

8. The method of claim 7, wherein operating the vehicle with the path polynomial within the free space map while avoiding non-stationary data points includes operating the vehicle on a roadway and avoiding other vehicles.

9. The method of claim 1, wherein video sensor data is based on processing video sensor data with a video data processor.

10. A system, comprising a processor; and
a memory, the memory including instructions to be executed by the processor to:
determine a free space map of an environment around a vehicle by combining video sensor data and radar sensor data;
determine a path polynomial by combining the free space map and lidar sensor data; and
operate the vehicle with the path polynomial.

11. The system of claim 10, wherein combining the video sensor data and the radar sensor data includes projecting video sensor data points and radar sensor data points onto the free space map based on determining a distance and direction from a video sensor or radar sensor, respectively, of the video sensor data points and the radar sensor data points.

12. The system of claim 11, wherein the free space map is a top-down map of an environment around the vehicle that includes a roadway and one or more other vehicles represented by stationary and non-stationary data points, respectively.

13. The system of claim 12, wherein determining the free space map further includes determining stationary data points and non-stationary data points based on video sensor data points and radar sensor data points.

14. The system of claim 13, wherein determining the free space map further includes fitting B-splines to a subset of stationary data points.

15. The system of claim 14, wherein determining the path polynomial further includes determining a predicted location with respect to the roadway based on the free space map including non-stationary data points and lidar sensor data.

16. The system of claim 15, wherein determining the path polynomial further includes applying upper and lower limits on lateral and longitudinal accelerations.

17. The system of claim 16, wherein operating the vehicle with the path polynomial within the free space map while avoiding non-stationary data points includes operating the vehicle on a roadway and avoiding other vehicles.

18. The system of claim 10, wherein video sensor data is based on processing video sensor data with a video data processor.

19. A system, comprising:
means for controlling vehicle steering, braking and powertrain;
computer means for:
determining a free space map of an environment around a vehicle by combining video sensor data and radar sensor data;
determining a path polynomial by combining the free space map and lidar sensor data; and
operating the vehicle with the path polynomial and means for controlling vehicle steering, braking and powertrain.

20. The system of claim 19, wherein combining the video sensor data and the radar sensor data includes projecting video sensor data points and radar sensor data points onto the free space map based on determining a distance and direction from a video sensor or radar sensor, respectively, of the video sensor data points and the radar sensor data points.
